(19) United States
(12) Patent Application Publication
(10) Pub. No.: US 2008/0036759 A1
(43) Pub. Date: Feb. 14, 2008

(54) Three-dimensional display device

(76) Inventors: Takafumi Koike, Sagamihara (JP); Michio Oikawa, Machida (JP); Kei Utsugi, Kawasaki (JP); Masami Yamasaki, Sagamihara (JP)

Correspondence Address: MCDERMOTT WILL & EMERY LLP, 600 13TH STREET, N.W., WASHINGTON, DC, 20005-3096, US

(21) Appl. No.: 11/819,946

(22) Filed: Jun. 29, 2007

(30) Foreign Application Priority Data
Jul. 21, 2006 (JP) 2006-199773

(51) Int. Cl. G06T 15/00

(52) U.S. Cl. 345/419

(57) ABSTRACT

Objects of the present invention are to widen a visual field of a three-dimensional image display device, and to improve the image quality of the three-dimensional image display device.

A number of pixels 51, 52 are formed on a two-dimensional image display device 1 for providing image data of a three-dimensional image. A lens array 2 constituted of a large number of micro lenses 3 is disposed on the two-dimensional image display device 1. Each of the micro lenses 3 is associated with a plurality of pixels 5, each of which emits the same color. In order to ensure a visual field θ required for the three-dimensional image, a diameter LD of each of the micro lenses 3, the distance DFL between each of the pixels 5 and each of the micro lenses 3 in the two-dimensional image display device, are properly set.

### CLAIM OF PRIORITY

The present application claims priority from Japanese Application JP 2006-199773 filed on Jul. 21, 2006, the content of which is hereby incorporated by reference into this application.

### BACKGROUND OF THE INVENTION

The present invention relates to three-dimensional image display devices, and more particularly to autostereoscopic display.

The autostereoscopic display are display devices that enable an observer to view a stereoimage without requiring the observer to use a particular tool such as glasses. As methods applied to the autostereoscopic display, there are various kinds of methods including the lenticular lens method and the holography method. However, the most of the methods are based on the principles that information on a light beam entering the eyes of an observer is controlled so that information on the light beam entering the left eye differs from information on the light beam entering the right eye, and the naked-eye stereoscopic vision is achieved based on the binocular disparity.

As one of the naked-eye stereoscopic vision display methods as described above, there is an integral photography (IP) method. Publicly known documents relating to three-dimensional image display devices based on this IP method include: (1) JP-A-1995-7747; (2) JP-A-2004-85965; and (3) M. G. Lippmann, Epreuves reversibles dormant la sensation du relief, pp. 821-825, Vol. 7, de Physi, 1908. Among these documents, the document (3) describes the principles of the IP method.

The document (1) describes a system that converts a three-dimensional image of an object into two-dimensional data by use of a lens array, and that reproduces the three-dimensional image by use of a similar lens array. The document (2) discloses that as measures against a problem of color moire that occurs when the IP method is used, each color filter corresponding to each of micro lenses constituting a lens array is colored with one color.

### SUMMARY OF THE INVENTION

Because of the principles of the IP method, three-dimensional image display devices based on the IP method are capable of displaying a stereoimage with a greatly improved stereoscopic effect in comparison with those based on the other methods. However, the IP method has the following problems: the resolution is low; a range within which a three-dimensional image can be identified (hereinafter referred to as a “visual field”) is not sufficient; color moire occurs; and the like.

The color moire is a phenomenon that as is the case with generally used display devices, if red, green, and blue pixels are adjacently disposed, when an image is viewed through each micro lens, only a red, green or blue image can be seen. In addition, the color moire is also a phenomenon that only a slight move of a viewing position causes the color of an image to change. As measures against the color moire, the document (2) discloses a technique for solving the color moire problem by associating each of micro lenses constituting a lens array with a color filter colored with only one color.

Although the technique disclosed in the document (2) has improve the color moire problem, the improvement in visual field, the improvement in resolution, and the like, are not achieved. Even if the color moire is improved, if a visual field is not sufficient, it is not possible to overcome the problem of a viewpoint that must be kept fixed. Moreover, if the required resolution is not achieved, it is not possible to acquire a three-dimensional image with high image quality.

The present invention has been made to solve the above-described problems, and objects of the present invention are to eliminate the color moire in a three-dimensional image display device based on the IP method, and to widen a visual field and increase the resolution. Specific configurations will be described as below.

(1) A three-dimensional image display device in which a number of micro lenses is disposed on a two-dimensional image display device having a number of pixels disposed in a matrix to display a three-dimensional image, wherein each of the micro lenses is provided for the plurality of pixels that emit the same color; and wherein, on the assumption that the distance between each of the pixels and the center of each of the micro lenses is DFL, if a diameter of each of the micro lenses is LD, a value of LD/DFL is 0.19 or more.

(2) The three-dimensional image display device according to Item (1), wherein the value of LD/DFL is 0.41 or more.

(3) The three-dimensional image display device according to Item (1), wherein the value of LD/DFL is 0.83 or more.

(4) The three-dimensional image display device according to Item (1), wherein the value of LD/DFL is 1.67 or more.

(5) The three-dimensional image display device according to Item (1) or (4), wherein the two-dimensional image display device is a liquid crystal display unit; and wherein the distance DFL between each of the pixels and the center of each of the micro lenses is the distance between each color filter of the liquid crystal display unit and the center of each of the micro lenses.

(6) The three-dimensional image display device according to Item (1) or (4), wherein the two-dimensional image display device is an organic EL display device; and wherein the distance DFL between each of the pixels and the center of each of the micro lenses is the distance between each light emission element of the organic EL display device and the center of each of the micro lenses.

(7) The three-dimensional image display device according to Item (6), wherein the two-dimensional image display device is a top emission type organic EL display device.

(8) A three-dimensional image display device in which a number of micro lenses is disposed on a two-dimensional image display device having a number of pixels disposed in a matrix to display a three-dimensional image, wherein one surface of each of the micro lenses is a convex, and the other surface thereof is substantially flat; and wherein, on the assumption that the distance between each of the pixels and the center of each of the micro lenses is DFL, if a diameter of each of the micro lenses is LD, a value of LD/DFL is 0.19 or more.

(9) The three-dimensional image display device according to Item (8), wherein the convex of the micro lens is located on the other side of the two-dimensional image display device.

(10) The three-dimensional image display device according to Item (8), wherein the convex of the micro lens is located on the side of the two-dimensional image display device.

(11) The three-dimensional image display device according to Item (9), wherein the two-dimensional image display device is a liquid crystal display unit.

(12) The three-dimensional image display device according to Item (9), wherein the two-dimensional image display device is an organic EL display device.

(13) The three-dimensional image display device according to Item (10), wherein the two-dimensional image display device is a liquid crystal display unit.

(14) The three-dimensional image display device according to Item (10), wherein the two-dimensional image display device is an organic EL display device.

(15) A three-dimensional image display device in which a number of micro lenses is disposed on a two-dimensional image display device having a number of pixels disposed in a matrix to display a three-dimensional image, wherein each of the micro lenses is provided for the plurality of pixels that emit the same color; and

each of the plurality of pixels corresponding to each of the micro lenses is a substantial rectangle, and a direction of a short side of the pixel substantially coincide with a direction in which the eyes of a person who views the three-dimensional image are lined up.

(16) A three-dimensional image display device in which a number of micro lenses is disposed on a two-dimensional image display device having a number of pixels disposed in a matrix to display a three-dimensional image, wherein each of the micro lenses is provided for the plurality of pixels that emit the same color; and wherein each of the plurality of pixels corresponding to each of the micro lenses is a substantial rectangle, and a direction of a long side of the pixel coincides with the vertical direction of a screen of the two-dimensional image display device.

(17) A three-dimensional image display device in which a number of micro lenses is disposed on a two-dimensional image display device having a number of pixels disposed in a matrix to display a three-dimensional image, wherein each of the micro lenses is provided for the plurality of pixels that emit the same color; wherein one surface of each of the micro lenses is a convex, and the other surface thereof is substantially flat; and wherein the micro lenses are spaced one another both in the vertical and horizontal directions.

(18) The three-dimensional image display device according to Item (17), wherein the micro lenses are formed of a resin sheet.

(19) The three-dimensional image display device according to Item (17), wherein the micro lenses are resin, and are formed on a glass sheet.

(20) The three-dimensional image display device according to Item (17), wherein the two-dimensional image display device is a liquid crystal display unit; and the micro lens are resin, and are formed on a polarizing plate of the liquid crystal display unit.

(21) The three-dimensional image display device according to Item (17), wherein the two-dimensional image display device is a bottom emission type organic EL display device; and the micro lens are resin and formed on a substrate on which an organic EL of the organic EL display device is formed.

(22) The three-dimensional image display device according to Item (17), wherein a black matrix is formed in the space between the micro lenses.

Effects obtained by the above-described three-dimensional image display devices are as follows.

According to the Items (1) to (7), since each of the microlenses is provided for only pixels, or color filters, each of which emits light with the same color, it is possible to prevent the color moire from occurring. Also, with a special relationship of a diameter of each micro lens with the distance between each micro lens and each color filter or each color pixel, it is possible to ensure a visual field required for a three-dimensional image.

According to the Items (8) or (14), one surface of each micro lens is a convex, and the other surface thereof is substantially flat. Accordingly, it is easy to form a lens array in the shape of a sheet. In addition, it is also easy to use the three-dimensional image display device in combination with a two-dimensional image display device that functions as a source of image information used to form a three-dimensional image.

According to the Items (15) and (16), it is possible to produce such an effect that the definition of the three-dimensional image is increased in appearance by making the amount of horizontal image information about a three-dimensional image compared with that of vertical image information about the three-dimensional image.

According to the means (17) or (22), because microlenses are spaced one another, it is possible to form a lens array by various methods. Therefore, it is possible to implement a three-dimensional image display device having various features at practical cost.

### BRIEF DESCRIPTION OF THE DRAWINGS

FIG. 1 is a diagram illustrating a basic configuration;

FIG. 2 is a diagram illustrating basic principles;

FIG. 3 is a diagram illustrating a visual field;

FIG. 4 is a plan view of a screen;

FIG. 5 is a diagram illustrating how pixels of a two-dimensional image display device are configured;

FIG. 6 is a cross sectional view of a liquid crystal display unit;

FIG. 7 is a cross sectional view of a three-dimensional image display device according to a first embodiment;

FIG. 8 is a cross sectional view of a three-dimensional image display device according to a second embodiment;

FIG. 9 is a cross sectional view of a three-dimensional image display device according to a third embodiment;

FIG. 10 is a cross sectional view of a bottom emission type organic EL display device;

FIG. 11 is a cross sectional view of a three-dimensional image display device according to a fourth embodiment;

FIG. 12 is a cross sectional view of a three-dimensional image display device according to a fifth embodiment;

FIG. 13 is a cross sectional view of a top emission type organic EL display device;

FIG. 14 is a cross sectional view of a three-dimensional image display device according to a sixth embodiment;

FIG. 15 is a plan view of a three-dimensional image display device according to a seventh embodiment;

FIG. 16 is a cross sectional view of a three-dimensional image display device according to the seventh embodiment;

FIG. 17 is a cross sectional view according to another mode of the seventh embodiment;

FIG. 18 is a cross sectional view according to still another mode of the seventh embodiment;

FIG. 19 is a cross sectional view according to a further mode of the seventh embodiment; and

FIG. 20 is a cross sectional view of a three-dimensional image display device according to an eighth embodiment.

### DESCRIPTION OF THE PREFERRED EMBODIMENTS

Embodiments of the present invention will be disclosed in detail as below.

### First Embodiment

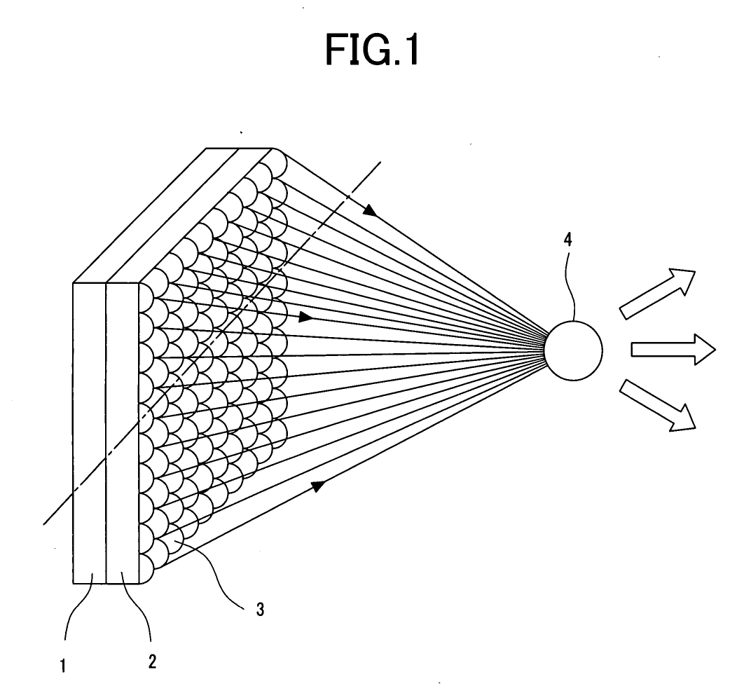

FIG. 1 is a diagram illustrating a basic configuration. A lens array 2 constituted of a large number of microlenses 3 is disposed on a two-dimensional image display device 1. The two-dimensional image display device 1 in this embodiment is a liquid crystal display panel. The two-dimensional image display device 1 generates a light spot 4 at an arbitrary position from the plurality of micro lenses 3. Under the lens array 2, there are a plurality of pixels, which form a light spot 4.

In conventional techniques, pixels, which emit or output red, green, and blue light, are disposed under each micro lens 3. However, according to the present invention, color filters colored with only one color are disposed under each micro lens 3. In this embodiment, the expression “under the micro lens 3” does not mean “directly under the micro lens 3”. For example, there is also a case where a light beam may be diagonally emitted in an area around a screen. In this case, a filter or a pixel 5 is not located at a position directly under the micro lens 3, but is shifted from the position to some degree. The expression of “under the micro lens 3” also includes this case.

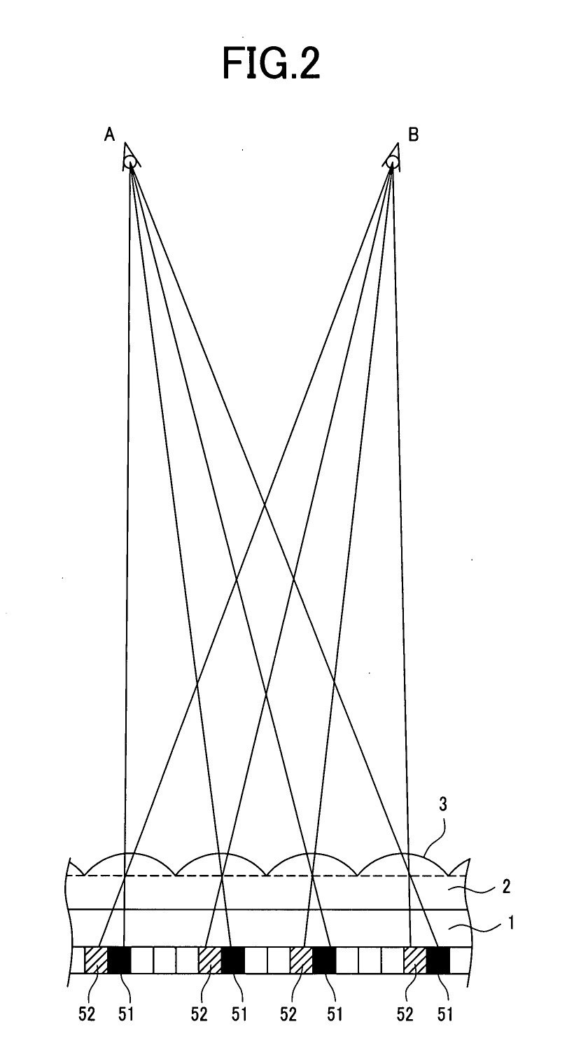

FIG. 2 is a diagram illustrating a cross sectional view taken along a dotted line shown in FIG. 1. More specifically, FIG. 2 is a cross sectional view taken along a plane including a horizontal line with respect to the lens array 2. In FIG. 2, a lens array having the large number of micro lenses 3 is located on the two-dimensional image display device 1 that provides three-dimensional image information. A large number of pixels 51, 52 are formed in the two-dimensional image display device. When looking the lenses from a viewpoint A, the pixel 51 can be seen through each lens, whereas when looking the lenses from an viewpoint B, the pixel 52 can be seen through each lens. Thus, because the left and right eyes perceive different images, stereoscopic vision can be achieved. Here, on the assumption that, as is the case with the conventional techniques, the pixel 51 is an image by a red filter, whereas the pixel 52 is an image by a green filter, only a red image is perceived at the viewpoint A, and only a green image is perceived at the viewpoint B, resulting in an unnatural image. In addition, if a viewpoint is slightly moved, differently colored images appear in succession, and what is called, color moire occurs. As a result, the image quality is remarkably deteriorated. According to the present invention, color filters colored with only one color are located under each of the micro lenses 3. Therefore, such moire does not occur.

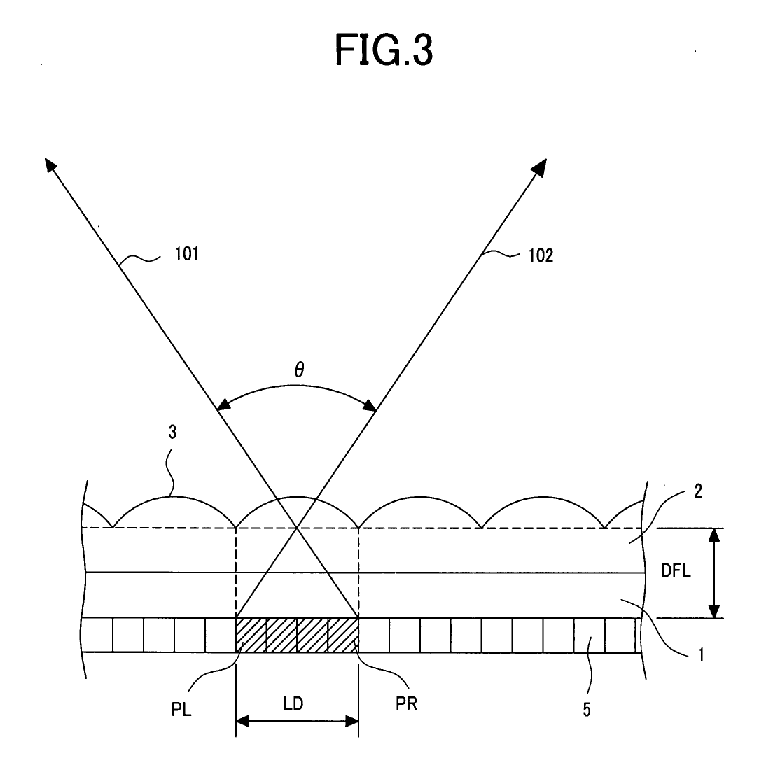

By locating color filters colored with only one color under each of the micro lenses 3, it is possible to prevent the color moire from occurring even if a viewpoint is shifted a little. However, the visual-field problem caused by the use of the micro lens 3 still remains unsolved. FIG. 3 is a diagram schematically illustrating the problem of a visual field. Each configuration is substantially the same as that described in FIG. 2. In FIG. 3, four pixels are provided for each of the micro lenses 3 and for each of color filters having the same color.

In FIG. 3, an angle θ made between a light beam 101 and a light beam 102 is the maximum range of the visual field. Here, the light beam 101 is emitted from the rightmost pixel PR under the color filter having the same color, and then passes through the center of the lens. The light beam 102 is emitted from the leftmost pixel PL under the color filter 60 having the same color, and then passes through the center of the lens. Specifically, because a light beam emitted from the pixel PR or PL at an angle larger than that of the light beam 101 or 102 does not pass through the corresponding micro lens 3, the light beam does not form a three-dimensional image. Accordingly, if a three-dimensional image is required, it is necessary that the viewing is made within a range of the angle θ across a vertical line to the screen. Incidentally, if a refractive index of a transparent envelope of the two-dimensional image display device is the same as that of the lens array, it may be considered that a light beam travels in a straight line.

The possible extent of the visual field θ is determined by the diameter LD of the micro lens 3, and the pixels, or the distance DFL to the color filter 60, which are shown in FIG. 3. Specifically, because tan (θ/2)=LD/2/DFL, θ=tan−1 LD/DFL. If the diameter LD of the micro lens 3 is made larger to increase the visual field θ, the resolution decreases. This is because the color resolution is determined by the size of the micro lens 3 according to the present invention. Therefore, if the color resolution is determined, the extent of the visual field is generally determined by the pixels, or the distance DFL between the color filter and the micro lens 3.

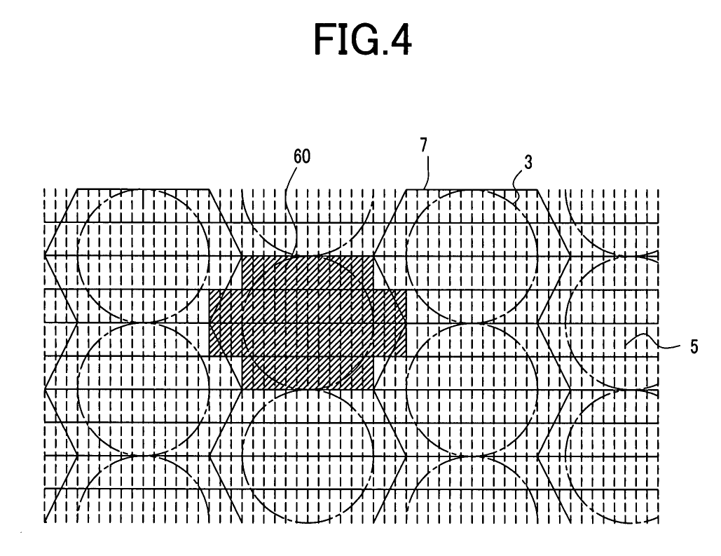

FIG. 4 is an enlarged plan view of FIG. 1, which is viewed from the top. In FIG. 4, each circle drawn with a broken line is a plan view of each of the micro lenses 3. Each of the micro lenses 3 is associated with color filters colored with only one color selected from red, green, blue, and the like. The micro lenses 3 used for red, those used for green, and those used for blue are arrayed in a delta arrangement. The micro lenses 3 are arrayed with no gap in the longitudinal direction as shown in FIG. 4. However, the micro lenses 3 are spaced from one another in the lateral direction. As a result, a visual field in the horizontal direction becomes larger than that in the vertical direction. Because the eyes of a human being are horizontally aligned and separated from each other, the visual field is widened in the horizontal direction. On the other hand, the color resolution per unit length in the horizontal direction becomes lower than that in the vertical direction.

In FIG. 4, each hexagon drawn with solid lines shows a shape that minutely fills up the screen. Specifically, the repetition of the hexagons makes it possible to fill up the screen with no gap. Hereinafter, this hexagon is referred to as a “cell 7”. In addition, lattice-shaped elements shown in FIG. 4, which are vertically long, are pixels 5. The pixels 5 are arranged under the micro lenses 3. More specifically, under each of the micro lenses 3, the pixels 5 are arranged in twelve rows in the horizontal direction, and in four columns in the vertical direction. Then, color filters colored with the same color are formed on these pixels 5 that are arranged under each of the micro lenses 3. The pixels 5 on which the color filters colored with the same color are formed are arranged not only under each of the micro lenses 3 but also in a manner that the pixels are aligned with the hexagons that minutely fill up the screen. Because each of the pixels 5 has a rectangular shape, the pixels 5 cannot be completely aligned with the hexagons that fill up the screen. Accordingly, the pixels 5 are arranged so that the pixels 5 each form a rectangular shape that is closely analogous to the hexagon.

Although each of the pixels 5 does not have a hexagonal shape, the pixels 5 also fill up the screen with no gap therebetween. For example, a portion drawn with oblique lines in FIG. 4 is a cell constituted of a set of the pixels 5 having a red filter. A set of the pixels 5 having a green color filter 60 and a set of the pixels 5 having a blue color filter 60 also have the same cell shape as that of the set of the pixels 5 having the red filter. Accordingly, these sets of the pixels 5 can completely fill up the screen.

By use of such a configuration, the pixels 5 which have the same color filter 60 are arranged in eighteen rows in the horizontal direction and in four columns in the vertical direction. Specifically, sixteen pieces of picture-element information in the horizontal direction are provided for each color, and four pieces of picture-element information in the vertical direction are provided for each color. Specifically, in the horizontal direction, each pixel can hold information required to display eighteen three-dimensional images. In addition, the amount of image information in the horizontal direction is larger than that of image information in the vertical direction. A three dimensional image which is based on, for example, the IP method is displayed by use of the parallax between the right and left eyes. Because the eyes of a human being are lined up in the horizontal direction, a larger amount of three-dimensional image information in the horizontal direction is provided. The number of pixels which form one cell is 60. More specifically, in order to display a three-dimensional image, 60 pieces of image information is provided for each color.

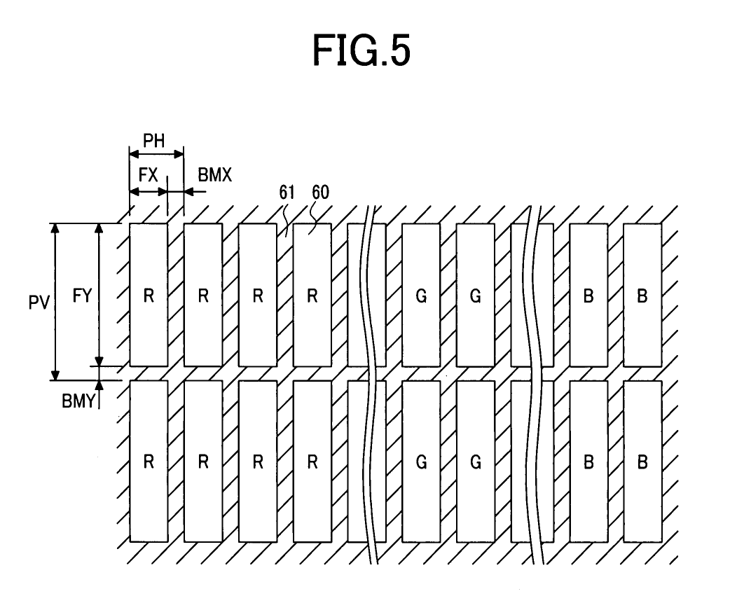

FIG. 5 is a diagram illustrating as an example how the pixels shown in FIG. 4 are arranged in the horizontal direction. As shown in FIG. 4, when the three-dimensional image display device is viewed from the above, in the case of a liquid crystal display unit 50, the color filter 60 corresponding to each pixel can be seen. Each pixel (that is to say, the color filter 60) has a horizontal pitch (PH) of 28 μm, and a vertical pitch (PV) of 84 μm. The color filter 60 has a diameter of 20 μm in the horizontal direction, and a diameter of 76 μm in the vertical direction. This arrangement corresponds to, what is called, the liquid crystal display unit 50 whose resolution is 300 BPI. A black matrix (BM) 61 is formed between the color filters 60. The roles of the BM 61 are to prevent leak light from coming from a backlight, and to improve the contrast.

In the case of general liquid crystal display units, colors of color filters, which are formed adjacently to each other, are different from each other. However, in this embodiment, as shown in FIG. 4, the color filters 60 colored with the same color are successively formed in a specified area, more specifically, in an area corresponding to one of the micro lenses 3. In addition, under the micro lens 3 that is spaced away from another micro lens 3 by the specified distance, the color filters 60 colored with another color are successively formed.

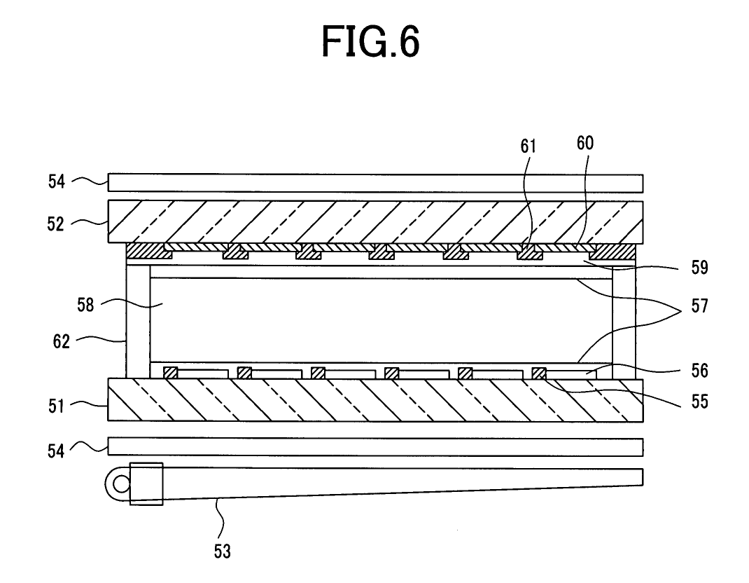

FIG. 6 is a cross sectional view schematically illustrating the liquid crystal display unit 50 used in this embodiment. In FIG. 6, a light beam coming from a backlight 53 enters a liquid crystal display panel. By controlling the light beam coming from the backlight 53 by the liquid crystal display panel, a minute two-dimensional image is formed. A polarizing plate 54 is affixed to the outside of a TFT substrate 51 of the liquid crystal display panel; and another polarizing plate 54 is affixed to the outside of a color filter substrate 52 of the liquid crystal display panel. A liquid crystal 58 is held tight between the TFT substrate 51 and the color filter substrate 52. The liquid crystal 58 is then sealed by sealants 62. A TFT (Thin Film Transistor) is formed on the TFT substrate 51. The TFT controls the voltage that is applied to the liquid crystal 58.

Picture element electrodes 56, each of which is constituted of a clear electrode ITO, are formed on the TFT substrate 51. Counter electrodes 59, each of which is constituted of a clear electrode ITO, are formed on the color filter substrate 52. By applying a voltage to the liquid crystal 58 located between each of the picture element electrodes 56 and each of the counter electrodes 59, a two-dimensional image is formed. An orientation layer 57 used to orient the liquid crystal 58 is formed on a surface of the TFT substrate 51, the surface facing the liquid crystal 58. Another orientation layer 57 is formed on a surface of the color filter substrate 52, the surface facing the liquid crystal 58.

Each of the color filters 60 is formed between the color filter substrate 52 and the counter electrode 59. In the case of generally used liquid crystal display units, filters colored with different colors such as red, green, and blue are formed on a picture element electrode 56 basis. However, according to this embodiment, a filter colored with the same color is formed for each of the cells 7 shown in FIG. 4. The BM 61 is formed between the filters. The BM 61 increases the contrast of an image by blocking a light beam traveling in a slanting direction, the light beam coming from the backlight 53, or the like. Therefore, even if pixels which are adjacent to each other use the color filters 60 colored with the same color, it is desirable to use the BM 61.

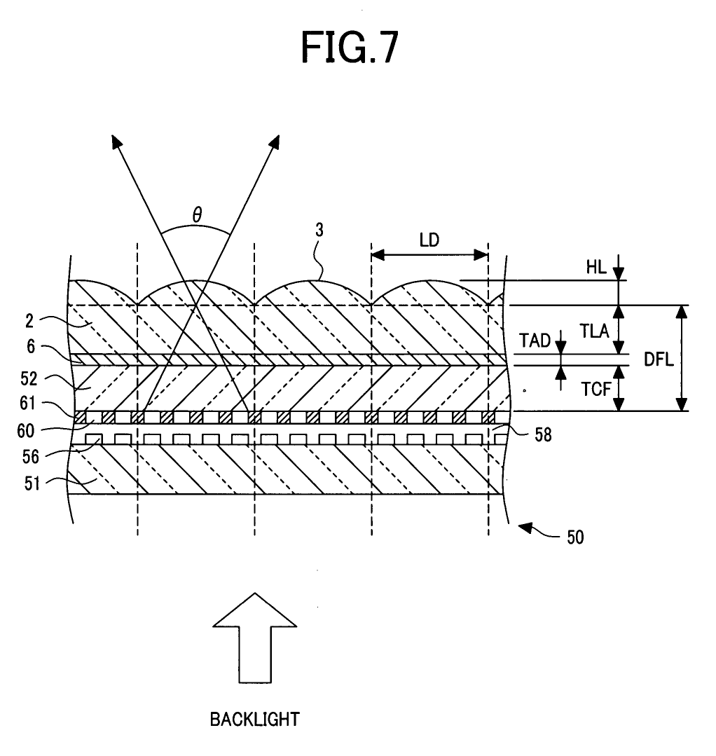

FIG. 7 is a cross sectional view schematically illustrating a three-dimensional image display device according to this embodiment. In FIG. 7, a cross section of the liquid crystal display unit 50 is simplified. The picture element electrode 56 is formed on the TFT substrate 51. The color filter 60 corresponding to the picture element electrode 56 is formed on the color filter substrate 52. The BM 61 is formed between the color filters 60. The color filters 60 colored with the same color are formed under one of the micro lenses 3.

In FIG. 7, the lens array 2 is disposed through transparent adhesive 6 on the color filter substrate 52 of the liquid crystal display panel. The lens array 2 according to this embodiment is formed by pouring transparent resin into a metal mold. In FIG. 7, in order to simplify the figure, four pixels 5 are assigned to each of the micro lenses 3. However, in actuality, as shown in FIG. 4, for example, sixteen pixels 5 are assigned to each of the micro lenses 3 in the horizontal direction.

Both the lens array 2 and the adhesive 6 are made of acrylic resin with high transparency. A refraction index of the acrylic resin is about 1.5. The color filter substrate 52 on the liquid crystal display unit side is made of non-alkali glass. A refraction index of the non-alkali glass is also about 1.5. Accordingly, as shown in FIG. 7, a light beam output from the color filter 60 passes through media, each of which has substantially the same refraction index, before the light beam reaches the micro lens 3. As a result, the light beam travels in a straight line with little refraction. Moreover, because a light beam passing through the center of the micro lens 3 travels in a straight line, it may be considered that a light beam, which is output from the color filter 60 located around the micro lens 3, and which passes through the center of the micro lens 3, travels in a straight line as indicated by arrows shown in FIG. 7.

Therefore, a visual field θ of the three-dimensional image display device can be expressed by a simple equation of θ=tan−1 LD/DFL as described with reference to FIG. 3. In this embodiment, the thickness TCF of the color filter substrate 52 is 0.5 mm; the thickness TAD of the adhesive 6 is 20 μm; and the thickness TLA of the array 2 of the micro lenses 3 is 0.3 mm. Therefore, a distance from the color filter 60 to the micro lens 3 is 0.82 mm. On the assumption that a diameter of the micro lens 3 is 0.336 mm, LD/DFL=0.41. Accordingly, the visual field θ is 22°. Therefore, if a user views an image at an angle within a range of 11° with respect to the vertical line of the screen, the user can perceive the image as a three dimensional image.

In this embodiment, because the horizontal pitch between the micro lenses 3 is 0.42 mm, which is larger than a diameter of the micro lens 3, LD/DF=0.51. As a result, the visual field is widened. The visual field θ is about 27°. However, the color resolution decreases by the increase in horizontal pitch.

In the above-described embodiment, when the diameter of the micro lens 3 is 0.336 mm, the thickness of the lens array 2 is 0.5 mm, the board thickness of the color filter substrate 52 including the polarizing plate 54 is 0.5 mm, and the thickness of the adhesive 66 is 0.02 mm, it is possible to keep the visual range within a range of the practical use although the visual field is narrowed. In this case, LD/DFL=0.33. If the visual field is evaluated by θ=tan−1 LD/DFL, the visual field is 18°.

If it is required to widen the visual field θ, it is necessary to increase the diameter LD of the microlens 3, or to decrease the distance DFL between the color filter 60 and the micro lens 3. If the diameter LD of the microlens 3 is increased, the color resolution decreases. From the viewpoint of the image quality, it is difficult to increase the diameter of the micro lens 3 to a value larger than 0.336 mm. On the other hand, it is possible to further decrease the distance DFL between the color filter 60 and the micro lens 3.

Currently, the thickness of the color filter substrate 52 of the liquid crystal display unit 50 is about 0.5 mm. However, by polishing this glass substrate, it is possible to thin the color filter substrate 52 up to a level of about 0.2 mm. Moreover, it is also possible to decrease the thickness of the array 2 of the micro lenses 3 to 0.1 mm or less depending on how to mold the array 2. On the assumptions that a diameter of the micro lens 3 is 0.336 mm, the thickness of the color filter substrate 52 is 0.3 mm, the board thickness of the array 2 of the micro lenses 3 is 0.1 mm, and the thickness of the adhesive 66 is 0.02 mm, LD/DFL=0.8. Accordingly, the visual field θ can be widened up to 39°.

If it is not necessary to widen the visual field up to 39°, it is possible to decrease the diameter of the micro lens 3 so that the color resolution is increased. By reducing the size of each of the pixels 5 together with the decrease in diameter of the micro lenses 3, it is possible to increase the resolution of the three dimensional image. On the assumptions that the thickness of the color filter substrate 52 is 0.2 mm, the board thickness of the array 2 of the micro lenses 3 is 0.1 mm, and the thickness of the adhesive 66 is 0.02 mm, if the diameter of the array 2 of the micro lenses 3 is 0.2 mm, then LD/DFL=0.48. Accordingly, it is possible to keep the visual field θ at 25°. On the other hand, on the basis of the same assumptions, if the diameter of the micro lens 3 is 0.1 mm, LD/DFL=0.31. Accordingly, it is possible to keep the visual field θ at 17°. If the diameter of the micro lens 3 can be decreased to a level of 0.1 mm, it can be said that the resolution sufficient for a three dimensional image is achieved.

### Second Embodiment

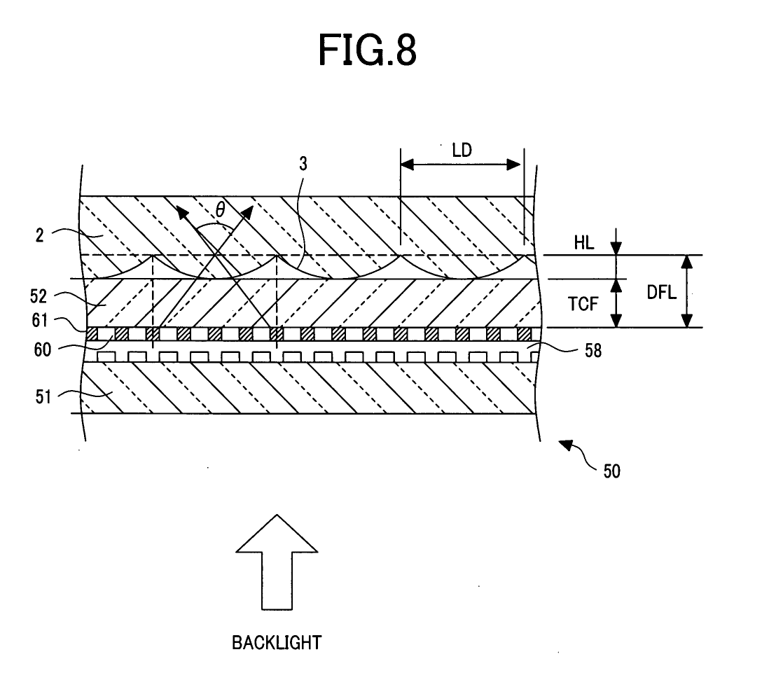

FIG. 8 is a diagram illustrating a second embodiment. An overall configuration of the second embodiment is the same as that of the first embodiment shown in FIG. 1. In addition, as is the case with the first embodiment, the liquid crystal display unit 50 is used. Elements in the liquid crystal display unit are also configured in the same manner as those of the first embodiment. In the second embodiment, with a direction of the lens array 2 being reverse to that of the first embodiment, the micro lenses 3 are disposed on the color filter substrate 52 side of the liquid crystal display unit 50. As a result, the distance between the color filter 60 and the micro lens 3 is decreased.

In FIG. 8, a light beam coming from the color filter 60 located around each of the micro lenses 3 travels in a straight line toward the center of the micro lens 3 in question. In the second embodiment, the distance from the color filter 60 to the center of the micro lens 3 is shortened because the thickness of a sheet of the lens array 2 may be ignored. In addition, in this embodiment, the micro lens 3 itself becomes a spacer used to determine the distance between the center of the micro lens 3 and the color filter 60.

In this embodiment, the distance DFL from the color filter 60 to the center of the micro lens 3 is the sum of the board thickness TCF of the color filter substrate 52 and the thickness HL of the micro lens 3. In this embodiment, the board thickness TCF of the color filter substrate 52 is 0.5 mm; and the thickness HL of the micro lens 3 is 0.03 mm. Moreover, because a diameter of the micro lens 3 is 0.336 mm, LD/DFL=0.65. Accordingly, the visual field θ becomes 33°. It is possible to acquire a considerably wider visual field in comparison with that of the first embodiment. Conversely, by decreasing the diameter of the micro lens 3 to a corresponding degree, it is possible to improve the color resolution of the three dimensional image.

In the second embodiment, even if the diameter of the micro lens 3 is decreased so as to increase the color resolution, it is possible to ensure a wider visual field in comparison with that of the first embodiment. For example, if the diameter of the micro lens 3 is decreased to 0.2 mm, the thickness of the lens is decreased to a corresponding degree. In this case, for example, the thickness of the lens is about 0.02 mm. If the thickness of the color filter substrate 52 is 0.5 mm, then LD/DFL=0.38. Therefore, it is possible to ensure a visual field θ of 21°. If the diameter of the micro lens 3 is 0.1 mm, LD/DFL=0.19. Therefore, it is possible to ensure a visual field θ of 11°. This level is a limit of the visual field.

In this embodiment, the thickness of the whole lens array 2 does not influence the visual field. Therefore, it is possible to improve the precision of the lens array 2 by increasing the board thickness of the lens array 2.

### Third Embodiment

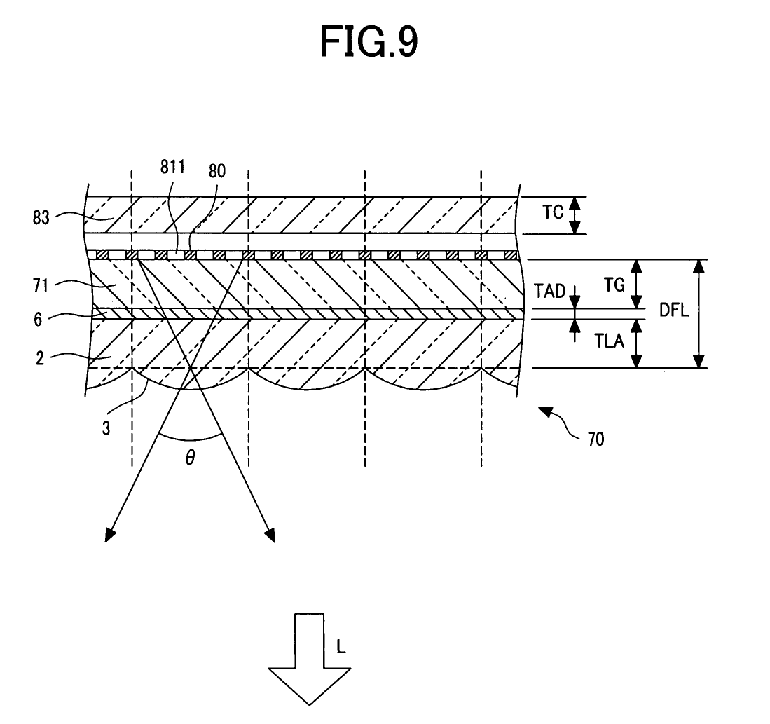

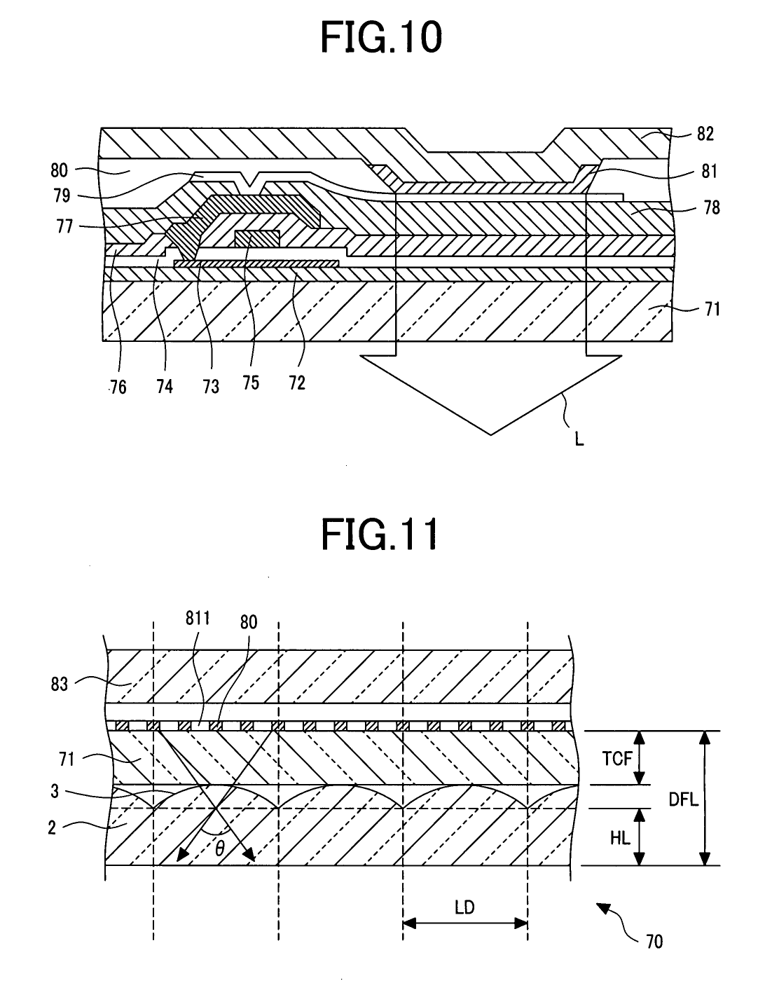

FIG. 9 is a diagram illustrating a third embodiment. In the third embodiment, a bottom emission type organic EL display device 70 is used as the two-dimensional image display device 1. FIG. 10 is a cross sectional view illustrating one pixel of the bottom emission type organic EL display device 70.

In FIG. 10, an undercoat 72 is formed on a glass substrate; and a semiconductor layer 73 constituting a TFT is formed on the undercoat 72. A gate insulating film 74 is formed to cover the semiconductor layer 73; and a gate electrode 75 is formed on the gate insulating film 74. Interlayer insulation film 76 is formed to cover the gate electrode 75. Source drain (SD) wiring 77, which is the same layer as signal wiring, is formed on the interlayer insulation film 76. The SD wiring layer 77 is connected to a drain of the semiconductor layer 73 through a through hole that is formed in the interlayer insulation film 76 and the gate insulating film 74. A passivation film 78 used to protect the TFT is formed to cover the SD wiring 77.

ITO film which is a transparent electrode is formed on the passivation film 78. The ITO film becomes a lower electrode 79 formed below an organic EL layer 81 that is used as a light emitting unit. The ITO film is connected to the SD wiring 77 through a through hole formed in the passivation film 78. The ITO film transfers a signal coming from the TFT to the organic EL film. In this case, the lower electrode 79 is used as an anode of the organic EL layer 81. After the lower electrode 79 is formed, a bank 80 for identifying each pixel is formed. After that, the organic EL layer 81 is deposited. The organic EL layer 81 is formed so as to include a plurality of layers. More specifically, from the side of the lower electrode 79, the organic EL layer 81 includes a hole injection layer, a hole transport layer, a light emission layer, an electron transport layer, an electron injection layer, and the like. An upper electrode 82 is formed on the top of the organic EL layer 81. The upper electrode 82 is made of metal, for example, Al or Al alloy. In this case, the upper electrode 82 is used as a cathode. A light beam emitted from the organic EL layer 81 is reflected by the upper electrode 82, and then travels in a direction indicated with an arrow L (travels toward the bottom).

FIG. 9 simply illustrates the bottom emission type organic EL display device 70 described with reference to FIG. 10. FIG. 9 illustrates the banks 80 and organic EL light emission elements 811 formed on the glass substrate 71 of the organic EL display device 70. A sealing glass plate 83 or a sealing member is formed on the top of the organic EL light emission elements 811 with a slight gap (for example, from 0.1 to 0.2 mm) being interposed therebetween. The role of the sealing glass plate 83 is to hermetically seal the organic EL layer 81 so that the inside of the organic EL layer 81 is kept dry, and thereby to eliminate the influence of moisture and the like from the outside.

The lens array 2 constituted of the large number of micro lenses 3 is formed on the glass substrate 71 through the transparent adhesive 6. In the organic EL layer 81 formed in this embodiment, a plurality of organic EL pixels which correspond to each of the micro lenses 3 perform the same light emission. A light emission color differs depending on a kind of material of the organic EL layer 81 shown in FIG. 10. The organic EL layer 81 is in general formed by mask deposition. In the case of the mask deposition, with the decrease in size of each pixel, the formation thereof becomes more difficult. In this embodiment, pixels which correspond to each of the micro lenses 3 can be formed by depositing the same part of the organic EL layer 81. Accordingly, a deposition process becomes easier than the deposition of the organic EL layer 81 whose color varies on a pixel basis. In FIG. 10, the organic EL layer 81 is separately formed on a pixel basis. However, so long as the organic EL layer 81 colored with the same color is deposited, the organic EL layer 81 may also be successively deposited.

Also in the third embodiment, the schematic plan view of the image display device is similar to that shown in FIG. 4 in the first embodiment. In FIG. 9, four pixels 5 correspond to one micro lens 3 for the sake of simplification. However, in actuality, for example, sixteen pixels 5 correspond to one micro lens 3. Each pixel has image information about a three dimensional image.

According to this embodiment, the size of each member relating to a visual field is substantially the same as that in the first embodiment. Specifically, also in this embodiment, the thickness TCF of the color filter substrate 52 is 0.5 mm; the thickness TAD of the adhesive 6 is 20 μm; and the thickness TLA of the array 2 of the micro lenses 3 is 0.3 mm. Therefore, the distance from the color filter 60 to the micro lens 3 is 0.82 mm. On the assumption that a diameter of the micro lens 3 is 0.336 mm, LD/DFL=0.41. Accordingly, the visual field θ is 22°.

In addition, the visual field can be widened, for example, by polishing the substrate to thin the substrate, or by thinning the lens array 2. This advantage is also the same as that of the first embodiment.

### Fourth Embodiment

FIG. 11 is a diagram illustrating a fourth embodiment. Also in this embodiment, the bottom emission type organic EL display device 70 described with reference to FIG. 10 is used. The lens array 2 is arranged in a direction opposite to that of the third embodiment so that the micro lenses 3 face the organic EL display device. This arrangement is made by replacing the liquid crystal display unit 50 with the organic EL display device 70 in the second embodiment.

Therefore, the principles of a visual field are the same as those in the third embodiment. Specifically, also in this embodiment, the distance DFL from the color filter 60 to the center of the micro lens 3 is the sum of the board thickness TCF of the color filter substrate 52 and the thickness HL of the micro lens 3. In this embodiment, the board thickness TCF of the color filter substrate 52 is 0.5 mm; and the thickness HL of the micro lens 3 is 0.03 mm. Moreover, because a diameter of the micro lens 3 is 0.336 mm, LD/DFL=0.63. Accordingly, the visual field θ becomes 32°. It is possible to obtain a considerably wider visual field in comparison with that of the third embodiment.

According to this embodiment, it is possible to achieve a wider visual field in comparison with that in the third embodiment. Because the visual field is widened, it is possible to decrease a diameter of the micro lens 3 to a corresponding degree. As a result, the color resolution can be increased. This advantage is also the same as that of the second embodiment.

### Fifth Embodiment

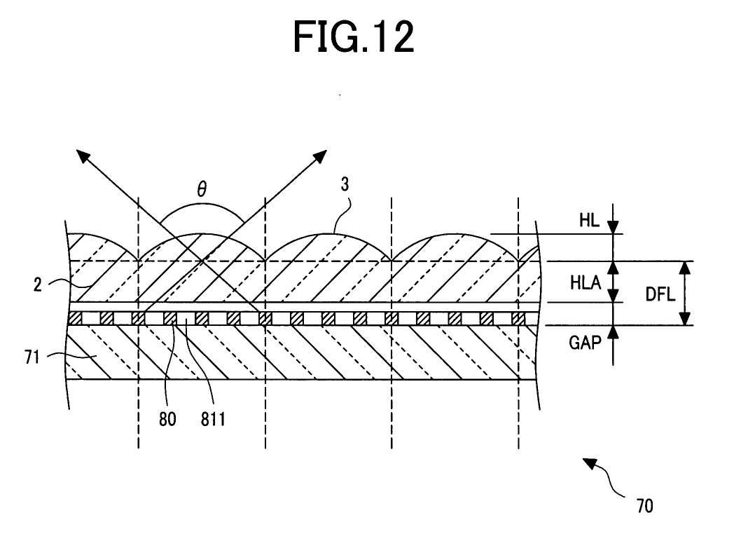

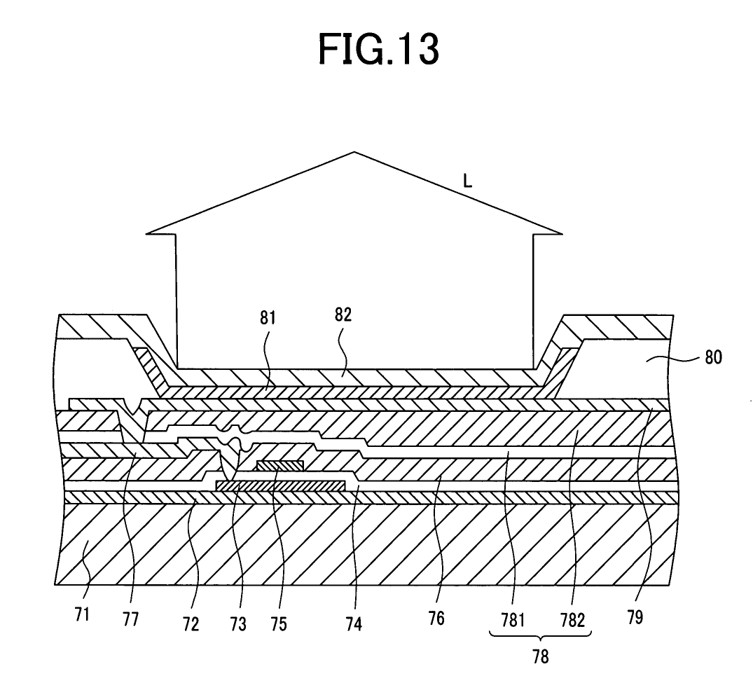

FIG. 12 is a diagram illustrating a fifth embodiment. In the second embodiment, what is called, a top emission type organic EL display device 70 is used as the two-dimensional image display device 1. The other elements are configured in the same manner as that of the first embodiment. FIG. 13 is a cross sectional view illustrating one pixel of the top emission type organic EL display device 70. Even if the organic EL display device 70 is top emission type, the organic EL display device 70 is configured in the same manner as the bottom emission type organic EL display device 70 except the organic EL layer 81 and its surrounding part.

In FIG. 13, until the SD wiring 77 is formed, the top emission type organic EL display device 70 has the same configuration as that of the bottom emission type organic EL display device shown in FIG. 10. In FIG. 13, inorganic passivation film 781 and organic passivation film 782 are coated on the SD wiring layer 77. In the case of the top emission type organic EL display device 70, light emission elements may be formed also on the TFT so as to increase the light emission area. Accordingly, in order to planarize a base of the organic EL layer 81 that is used as the light emission elements, the organic passivation film 782 is coated.

The lower electrode 79 is formed on the organic passivation film 782. The lower electrode 79 is connected to the SD wiring 77 through a through hole that is formed in the organic passivation film 782 and the inorganic passivation film 781. The lower electrode 79 applies the voltage supplied from the TFT to the organic EL layer 81. In this case, the lower electrode 79 is used as a cathode of the organic EL layer 81. In addition, the lower electrode 79 is formed by, for example, Al or Al alloy, whose reflection factor is high. After the lower electrode is formed, the banks 80 used to identify each pixel are formed. Then, the organic EL layer 81 is formed by deposition.

The organic EL layer 81 is formed so as to include a plurality of layers. From the lower electrode 79 side, the organic EL layer 81 includes, for example, an electron injection layer, an electron transport layer, a light emission layer, a hole transport layer, and a hole injection layer. The upper electrode 82 of the organic EL layer 81 is a positive electrode. The upper electrode 82 is formed by a transparent electrode such as ITO. Through the transparent electrode ITO, a light beam emitted from the organic EL layer 81 goes out to the top as indicated with an arrow L shown in FIG. 13 (top emission).

FIG. 12 simply illustrates the top emission type organic EL display device 70 described with reference to FIG. 13. The banks 80, and the organic EL light emission elements 811 used as light emission elements, are formed on the glass substrate 71. Under each of the microlenses 3, the organic EL layer 81 for emitting a light beam having the same color is formed. The organic EL layer 81 is in general formed by deposition mask. Therefore, if the same organic EL material covering a plurality of pixels is successively formed, the process becomes easier than the formation of each different part of the organic EL layer 81 on a pixel basis.

In FIG. 12, the lens array 2 is formed above the organic EL layer 81 with a slight gap (for example, 0.1 mm) being interposed therebetween. The organic EL layer 81 is hermetically sealed by the lens array 2. If the lens array 2 is not formed, the organic EL is hermetically sealed by the sealing glass plate 83. Therefore, the lens array 2 also functions as the sealing glass plate in this embodiment.

The visual field θ shown in FIG. 12 will be evaluated as below. The distance DFL between the organic EL light emission element 811 and the center of the micro lens is the sum of the gap GAP between the organic EL light emission element 811 and the lens array 2 and the thickness HLA of the lens array 2. Here, the gap GAP between the organic EL light emission element 811 and the lens array 2 is 0.1 mm; and the thickness HLA of the lens array 2 is 0.3 mm. Because a diameter of the micro lens 3 is 0.336 mm, LD/DFL=0.84, and accordingly the visual field θ is 40°. Therefore, it is possible to make the visual field about twice that of the third embodiment in which the bottom emission type organic EL display device is used. However, in this embodiment, because the lens array 2 is used as both the hermetic sealing member and guard member of the organic EL layer 81, it is not possible to extremely reduce the board thickness of the lens array 2.

### Sixth Embodiment

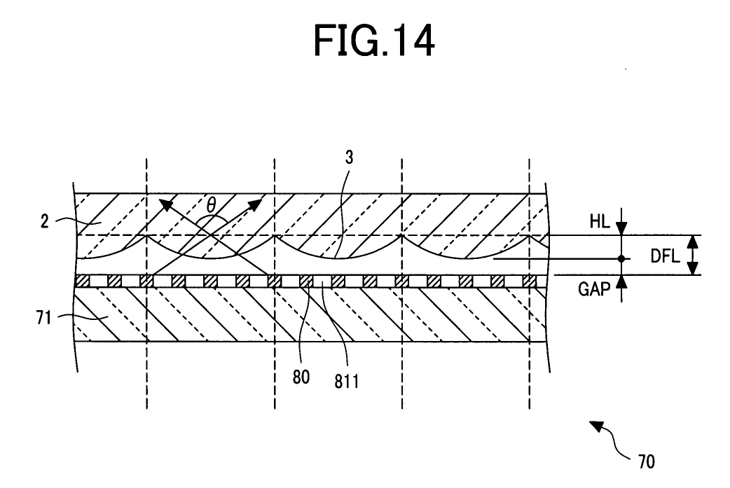

FIG. 14 is a diagram illustrating a sixth embodiment. As is the case with the fifth embodiment, a top emission type organic EL display device is used as the two-dimensional image display device 1 in this embodiment. A point of difference between the fifth and sixth embodiments is that the lens array 2 does not face the outside but faces the organic EL display device side. In addition, the planar relationship between each of the micro lenses 3 and each of the pixels 5 is the same as that shown in FIG. 4 in the first embodiment.

As understood from FIG. 14, in this embodiment, it is possible to greatly decrease the distance between the organic EL light emission element 811 and the micro lens 3, and thereby to widen the visual field e to a corresponding degree. A visual field in this embodiment is evaluated as below. The distance between the organic EL light emission element 811 and the micro lens 3 is the sum of a gap (0.1 mm) between the lens array 2 and the organic EL light emission element 811 and the thickness HL (0.03 mm) of the micro lens 3. On the assumption that a diameter of the micro lens 3 is 0.336 mm, LD/DFL=2.6. Accordingly, the visual field θ is 69°. It is possible to extremely widen the visual field θ in comparison with that in the other embodiments.

Therefore, in comparison with the other embodiments, this embodiment makes it possible to more easily narrow the visual field to some degree so that the color resolution is improved to a corresponding degree. For example, if a diameter of the micro lens 3 is 0.2 mm, the thickness of the micro lens 3 is about 0.02 mm. If a gap between the organic EL layer 81 and the micro lens 3 is 0.1 mm, then LD/DFL=1.67. Therefore, it is possible to achieve a visual field θ of 59°. If the diameter of the micro lens 3 is decreased to 0.1 mm, the thickness of the micro lens 3 is about 0.02 mm. If a gap between the organic EL layer 811 and the micro lens 3 is 0.1 mm, then LD/DFL=0.83. Therefore, it is possible to keep the visual field θ at 40°. In this embodiment, the board thickness of a sheet of the lens array 2 does not substantially influence the visual field θ. Accordingly, if the lens array 2 is formed of relatively thick glass whose thickness is about 0.5 mm, it is possible to achieve the high reliability of the guard member of the organic EL film.

### Seventh Embodiment

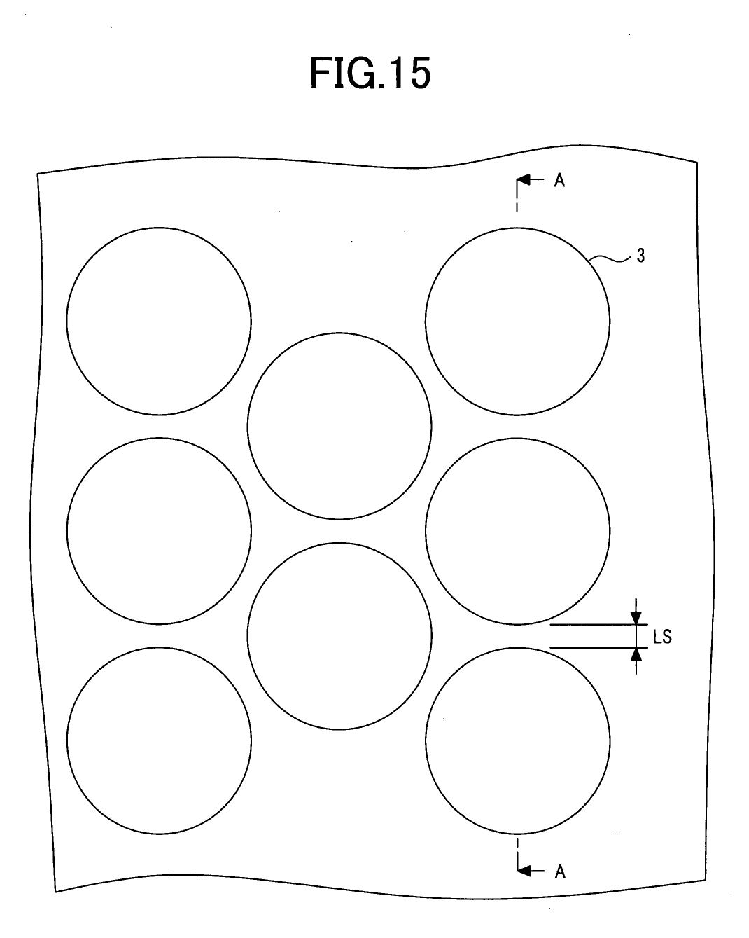

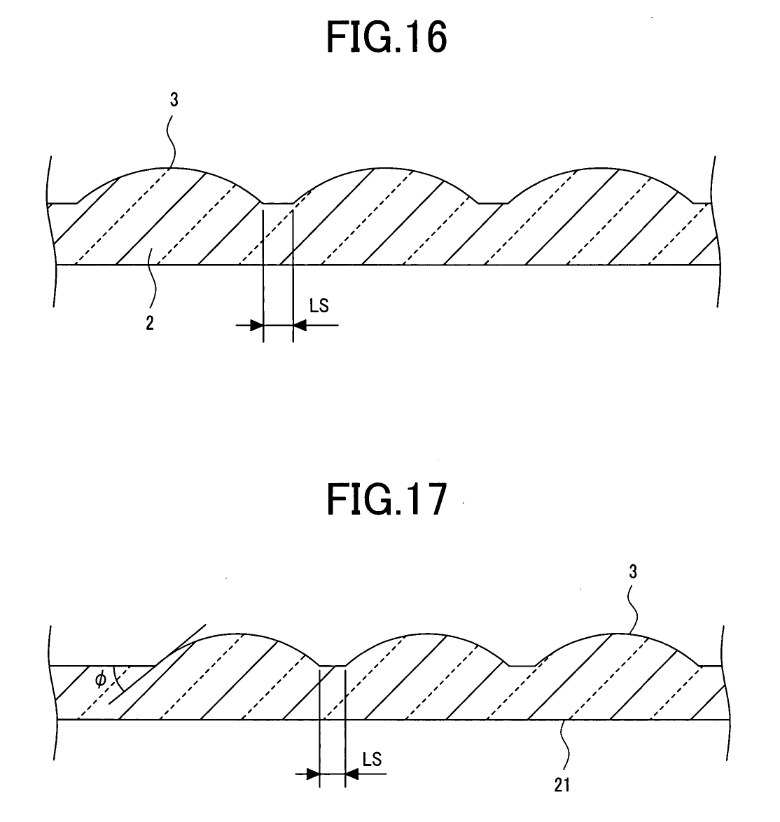

FIG. 15 is an enlarged plan view partially illustrating the lens array 2 according to this embodiment. The micro lens 3 is part of a sphere, and a plan view thereof is a circle. In this embodiment, both in the vertical and horizontal directions, there is a gap LS between the micro lenses 3 that are adjacent to each other. FIG. 16 is a cross-sectional view taken along A-A line of FIG. 15. Thus, each gap existing between the adjacent micro lenses 3 makes it possible to eliminate the interference between the adjacent micro lenses 3. As a result, it is possible to ensure specified curvature in and around each of the micro lenses 3. In FIG. 15, the gaps LS are the same both in the horizontal and vertical directions. However, the gap LS in the horizontal direction may also differ from that in the vertical direction.

Even if each gap LS between the adjacent micro lenses 3 is about as large as the width (BMX or BMY) of the BM 61 in the arrangement of the pixels shown in FIG. 5, the image quality is not influenced by the gaps LS. If the size of each gap LS is about twice the horizontal pitch PH in FIG. 5, substantially no influence is exerted on the image quality. A larger gap may also be required depending on a method for producing the micro lenses 3. However, the gap LS may be determined in consideration of the image quality.

In the first embodiment, and the like, the lens array 2 is formed by pouring the resin into the metal mold. However, if the micro lenses 3 are disposed with each gap LS being interposed therebetween, it is possible to produce the micro lenses 3 by various methods. As methods for producing the lens array 2 with resin, not only the method described in the embodiment, but also a method in which transparent resin such as acryl is formed by pressing can be adopted.

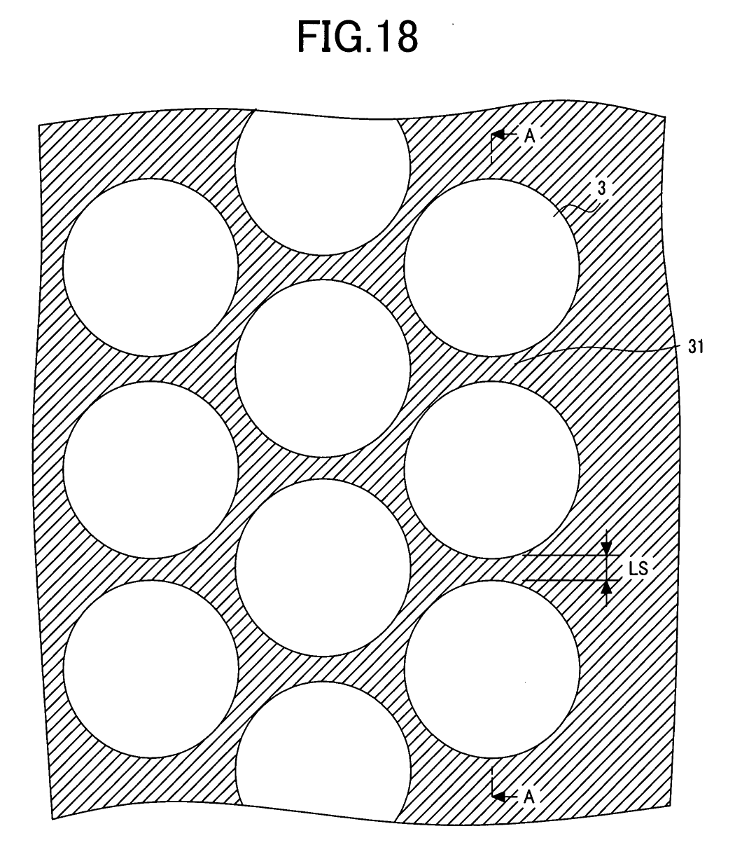

On the other hand, it is also possible to perform offset printing on a lens array substrate such as a glass plate with resin being kept in a liquid state. In this case, by properly setting the wettability of the liquid resin with respect to the substrate such as glass as shown in FIG. 17, it is possible to design a contact angle φ formed with the substrate such as glass, and thereby to form the micro lenses 3 as shown in FIG. 17.

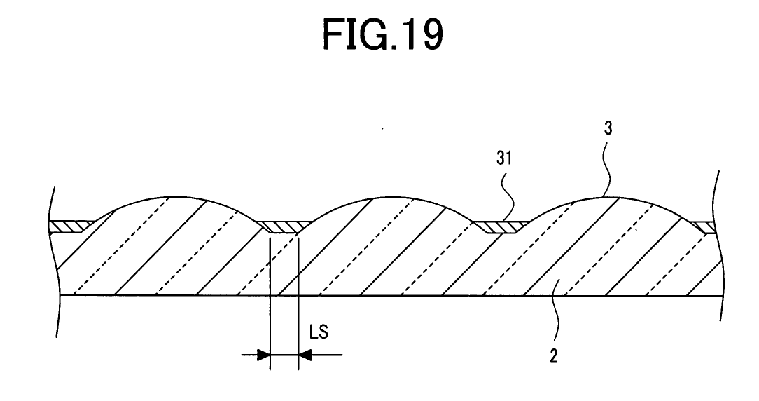

As shown in FIGS. 18, 19, by forming BM in each gap between the adjacent micro lenses 3 to fill up each gap with the BM, it is possible to prevent the interference between pixels corresponding to other micro lenses 3. The BM 31 is formed by the photolithography method. However, because the BM 31 is formed in a flat area between the adjacent micro lenses 3 in this embodiment, it is possible to improve the precision of the production.

### Eighth Embodiment

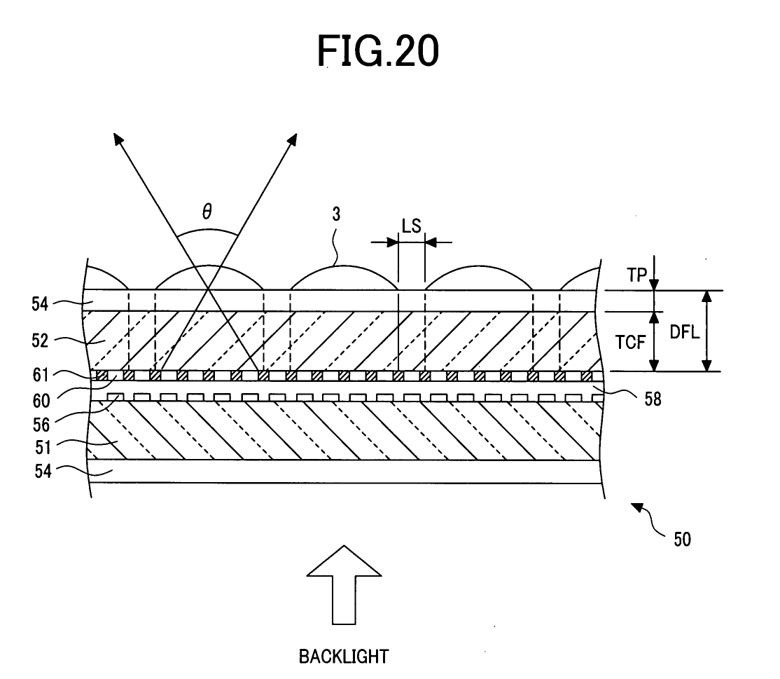

FIG. 20 is a diagram illustrating an eighth embodiment. In this embodiment, the liquid crystal display unit 50 is used as the two-dimensional image display device 1. However, the lens array 2 is not used as a separate element. The micro lenses 3 are formed by offset printing. Specifically, the polarizing plate 54 is affixed both to the outside of the TFT substrate 51 and to the outside of the color filter substrate 52, and as a result, the production of the liquid crystal display panel is completed. In this embodiment, however, after the above-described process, the micro lenses 3 are offset-printed on the polarizing plate 54 on the color filter side. Because there is the gap LS between the adjacent micro lenses 3, it becomes possible to form the micro lenses 3 by the offset printing.

The micro lenses 3 are arranged in the same manner as that shown in FIG. 15. Each of the cells 7 shown in FIG. 4 is formed on a micro lens 3 basis. Each of the cells 7 has a large number of pixels 5 each emitting the same color. The cells 7 have a shape of a horizontally long hexagon in the first embodiment. However, the cells 7 have a shape of a regular hexagon in this embodiment. As a matter of course, it is not necessary to stick to a regular hexagon. Determining a horizontal to vertical ratio of a hexagon on the basis of requirements for the resolution and the visual field suffices.

In this embodiment, because expensive lens array components can be omitted, there is a large cost advantage. Another advantage of this embodiment is that because lens array components are not used, the thickness of the sheet of the lens array can be ignored, and accordingly it is possible to achieve a wide visual field.

The visual field in the eighth embodiment will be evaluated as below. Here, the thickness TCF of the color filter substrate 52 is 0.5 mm; and the thickness of the polarizing plate 54 is 0.1 mm. Here, the thickness TCF of the color filter substrate 52 is 0.5 mm; and the thickness of the polarizing plate 54 is 0.1 mm. If a diameter of the micro lens 3 is 0.336 mm, then LD/DFL=0.56, and accordingly the visual field θ is 29°. Therefore, the visual field θ is more greatly widened in comparison with that of the first embodiment.

As described in the eighth embodiment, the liquid crystal display unit is used as the two-dimensional image display device 1. However, even if the bottom emission type organic EL display device is used, the present invention can be applied to the eighth embodiment in like manner.

In the embodiments described above, color filters or light emission colors are red, green, and blue. However, to improve the luminosity, or to increase a color reproduction range, a filter colored with another color, or the emission of light with another color, may also be used. Nevertheless, the present invention can also be applied to this case.

If the liquid crystal display unit is used as the two-dimensional image display device, the case where the color filters are used was described as the embodiment. Besides the above-described color liquid crystal display units, there is also a color liquid crystal display unit that uses a driving method, what is called, the field sequential method, in which instead of using color filters, for example, red, green, and blue light sources are used for backlight, and light emission of each of the red, green, and blue light sources is performed in a time-sharing manner to achieve color displaying. It is needless to say that the present invention can also be applied to this case.

What is claimed is:

1. A three-dimensional image display device comprising:
a two-dimensional image display device having a plurality of pixels disposed in a matrix; and
a plurality of micro lenses disposed on the two-dimensional image display device to display a three-dimensional image, wherein:
each of the micro lenses is associated with the plurality of pixels that emit the same color; and
on the assumption that a distance between each of the pixels and the center of each of the micro lenses is DFL and that a diameter of each of the micro lenses is LD, a value of LD/DFL is 0.19 or more.

2. The three-dimensional image display device according to claim 1, wherein:
the value of LD/DFL is 0.41 or more.

3. The three-dimensional image display device according to claim 1, wherein:
the value of LD/DFL is 0.83 or more.

4. The three-dimensional image display device according to claim 1, wherein:
the value of LD/DFL is 1.67 or more.

5. The three-dimensional image display device according to claim 1, wherein:
the two-dimensional image display device is a liquid crystal display unit; and
the distance DFL between each of the pixels and the center of each of the micro lenses is equal to the distance between each color filter of the liquid crystal display unit and the center of each of the micro lenses.

6. The three-dimensional image display device according to claim 1, wherein:
the two-dimensional image display device is an organic EL display device; and
the distance DFL between each of the pixels and the center of each of the micro lenses is equal to a distance between each light emission element of the organic EL display device and the center of each of the micro lenses.

7. The three-dimensional image display device according to claim 6, wherein:
the two-dimensional image display device is a top emission type organic EL display device.

8. A three-dimensional image display device comprising:
a two-dimensional image display device having a plurality of pixels disposed in a matrix; and
a plurality of micro lenses disposed on the two-dimensional image display device to display a three-dimensional image, wherein:
one surface of each of the micro lenses is a convex, and the other surface thereof is substantially flat; and
on the assumption that the distance between each of the pixels and the center of each of the micro lenses is DFL and that a diameter of each of the micro lenses is LD, a value of LD/DFL is 0.19 or more.

9. The three-dimensional image display device according to claim 8, wherein:
the convex of each of the micro lenses is located on the other side of the two-dimensional image display device.

10. The three-dimensional image display device according to claim 8, wherein:
the convex of each of the micro lenses is located on the side of the two-dimensional image display device.

11. The three-dimensional image display device according to claim 9, wherein:
the two-dimensional image display device is a liquid crystal display unit.

12. The three-dimensional image display device according to claim 9, wherein:
the two-dimensional image display device is an organic EL display device.

13. The three-dimensional image display device according to claim 10, wherein:
the two-dimensional image display device is a liquid crystal display unit.

14. The three-dimensional image display device according to claim 10, wherein:
the two-dimensional image display device is an organic EL display device.

15. A three-dimensional image display device comprising:
a two-dimensional image display device having a plurality of pixels disposed in a matrix; and
a plurality of micro lenses disposed on the two-dimensional image display device to display a three-dimensional image, wherein:
each of the micro lenses is associated with the plurality of pixels that emit the same color; and
each of the plurality of pixels corresponding to each of the micro lenses is a substantial rectangle, and a direction of a short side of the pixel substantially coincide with a direction in which the eyes of a person who views the three-dimensional image are arranged.

16. A three-dimensional image display device comprising:
a two-dimensional image display device having a plurality of pixels disposed in a matrix; and
a plurality of micro lenses disposed on the two-dimensional image display device to display a three-dimensional image, wherein:
each of the micro lenses is associated with the plurality of pixels that emit the same color; and
each of the plurality of pixels corresponding to each of the micro lenses is a substantial rectangle, and a direction of a long side of the pixel coincides with the vertical direction of a screen of the two-dimensional image display device.

17. A three-dimensional image display device comprising:
a two-dimensional image display device having a plurality of pixels disposed in a matrix; and
a plurality of micro lenses disposed on the two-dimensional image display device to display a three-dimensional image, wherein:
each of the micro lenses is associated with the plurality of pixels that emit the same color; and
one surface of each of the micro lenses is a convex, and the other surface thereof is substantially flat; and
the micro lenses are spaced one another both in the vertical and horizontal directions.

18. The three-dimensional image display device according to claim 17, wherein:
the micro lenses are formed of a resin sheet.

19. The three-dimensional image display device according to claim 17, wherein:
the micro lenses are resin and formed on a glass sheet.

20. The three-dimensional image display device according to claim 17, wherein:
the two-dimensional image display device is a liquid crystal display unit; and
the micro lens are resin and formed on a polarizing plate of the liquid crystal display unit.

21. The three-dimensional image display device according to claim 17, wherein:
the two-dimensional image display device is a bottom emission type organic EL display device; and
the micro lens are resin and formed on a substrate on which an organic EL of the organic EL display device is formed.

22. The three-dimensional image display device according to claim 17, wherein:
a black matrix is formed in a space between the micro lenses.
